(19) United States
(12) Patent Application Publication
(10) Pub. No.: US 2006/0272214 A1
(43) Pub. Date: Dec. 7, 2006

(54) Automatized solar shielding system

(75) Inventors: Giuseppe Simonelli, Colfelice (IT); Giorgio Simonelli, Colfelice (IT); Tarquinio Simonelli, Colfelice (IT)

Correspondence Address: BROWDY AND NEIMARK, P.L.L.C.;624 NINTH STREET, NW, SUITE 300, WASHINGTON, DC, 20001-5303, US

(73) Assignee: CDR S.R.L., Colfelice (IT)

(21) Appl. No.: 10/549,174

(22) PCT Filed: Mar. 10, 2004
(86) PCT No.: PCT/IB04/50222

§ 371 Date: Aug. 7, 2006

(30) Foreign Application Priority Data
Mar. 17, 2003 (IT) FR2003U000005

(51) Int. Cl. E06B 7/08

(52) U.S. Cl. 49/92.1; 49/74.1; 49/82.1

(57) ABSTRACT

Automatized solar shielding system, comprising a plurality of slats (1) revolvable via a driving device driven by a motor (13), and a pair of uprights supporting the slats (1), wherein one upright contains the driving device and one of the sunshade slats (1) contains the motor (13).

The present invention refers to an automatized solar shielding system.

The contrived device finds application in the field of building as a system for protecting from solar rays and as a furniture fitting for windows, glazed frames and all those surfaces requiring partial or total shielding from the outside, and in particular from solar radiance.

Shielding systems substantially shutter-shaped and provided with revolving sunshade slats are already known. In the state of the art, the light-related tilt of the shielding surfaces forming the roller shutter is commonly adjusted via a manually operated driving device, with obvious and evident disadvantages deriving from the manual operation, the weight of the structures to be shifted and the fragility of some parts of the device.

Likewise, systems providing a motorized driving device are known.

Such a device is represented by a metal rod running along the entire height of the sunshade system and to which the individual slats are individually and rotatably connected at respective ends thereof.

The motion revolving the sunshade slats is transmitted thereto via said rod, to which they are suitably hinged.

The motion is imparted either manually, by actuating a lever located on an upright, or with a motor that, via a gears/rack system, imparts a translatory motion to the abovementioned rod.

However, the solutions for driving the known sunshades entail several drawbacks.

These drawbacks are aesthetical, and above all technical.

An aesthetical drawback lies in that the entire driving apparatus is external to the structure of the sunshade system, hence apparent to the view. Of course, this could be a drawback when the sunshade system is used as furniture fitting, i.e. also with an architectural and/or design value.

The technical drawbacks, likely to be of a more widespread concern, lie above all in that since the entire driving device is external to the bearing structure of the system, external agents may intervene to alter the integrity of the latter.

In particular, atmospheric agents (moisture having a corrosive action; sudden thermal changes entailing expansion and shrinkage of metal and plastic parts, etc.) attack and harm the driving system in its mechanical and electrical parts, prejudicing its operation, with the entailed demand of a frequent and substantial maintenance.

Moreover, the entire device, being external to the structure is also remarkably at risk of vandalisms that could prejudice its correct operation.

In addition, the motor used and the motion transmission modes do not allow to simply and rapidly vary the parameters regulating its stroke and the ensuing revolving of the sunshade slats.

The present invention is proposed as an innovative solution to the problems highlighted hereto, concomitantly introducing improvements where the commonly used sunshades prove ineffective and unreliable.

These results are attained by means of an automatized sunshade slat system as set forth in the independent claim 1.

This solution is implemented on the one hand by enclosing the rotary driving device in an upright, and on the other hand by using for the driving itself a tubular motor inserted inside of one of the sunshade slats.

A first advantage of the system according to the present invention lies in that it substantially eliminates the harmful effects of the external atmospheric agents and it ensures a higher protection of the motor and of the mechanical and electronic parts, even from any tampering damages.

Moreover, a second advantage lies in that the technical solutions adopted allow a simplified mounting and adjusting, as well as a more direct procedure for revolving the sunshade slats. This turns into a saving of maintenance times and a markedly improved maneuverability.

These and other advantages, as well as the features and the modes of employ of the present invention, will be made apparent in the following detailed description of an embodiment thereof, given by way of a non-limiting example, making reference to the figures of the annexed drawings, wherein:

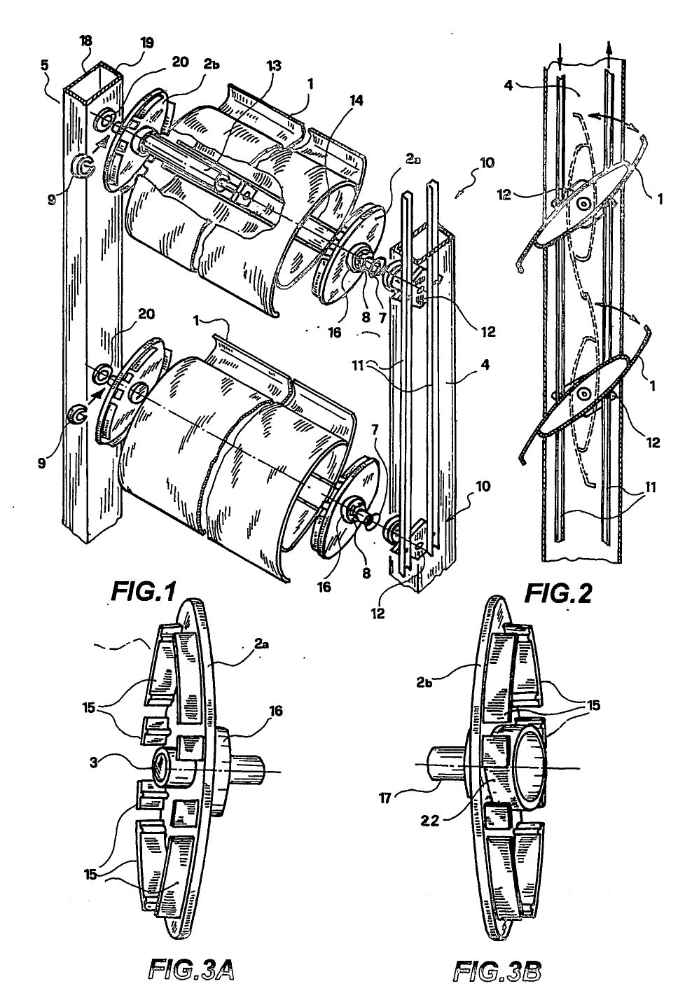

FIG. 1 is an exploded view of a portion of a sunshade system according to the present invention;

FIG. 2 is a partially sectional side view of the system of FIG. 1;

FIGS. 3A and 3B are perspective views of caps of the sunshade slats;

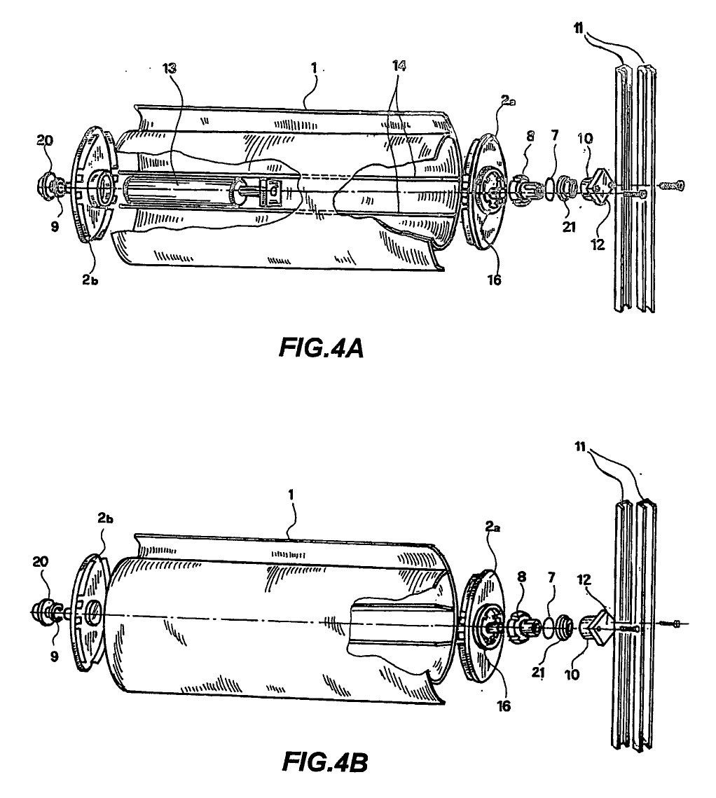

FIG. 4A is an exploded and partially sectional view of a sunshade slat comprising a driving motor;

FIG. 4B is an exploded and partially sectional view of a sunshade slat;

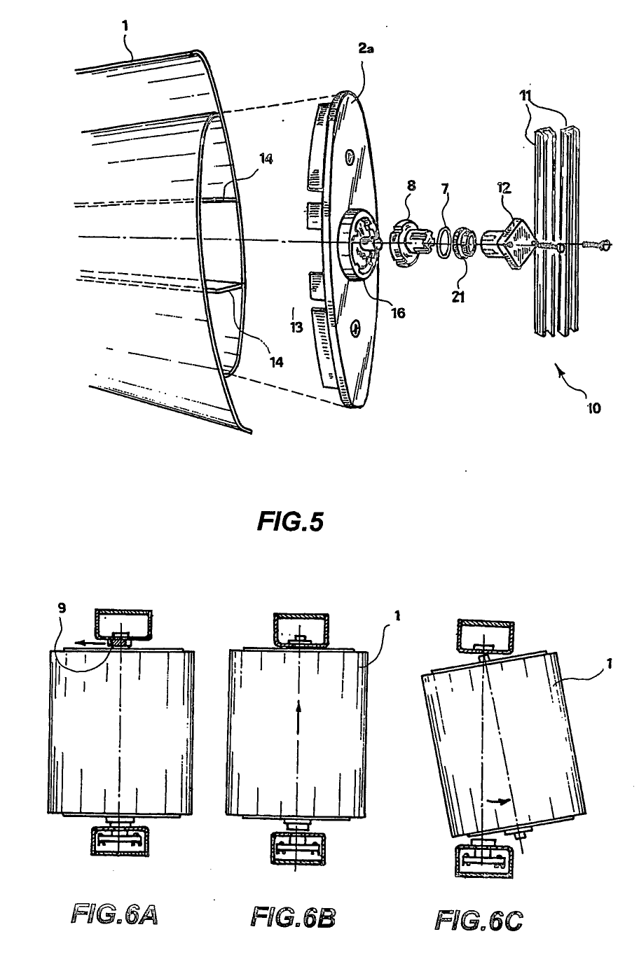

FIG. 5 is an exploded and detailed view of the slat of FIG. 4A;

FIGS. 6A, 6B, 6C exemplify the process of inserting/extracting the slats into/from their seat;

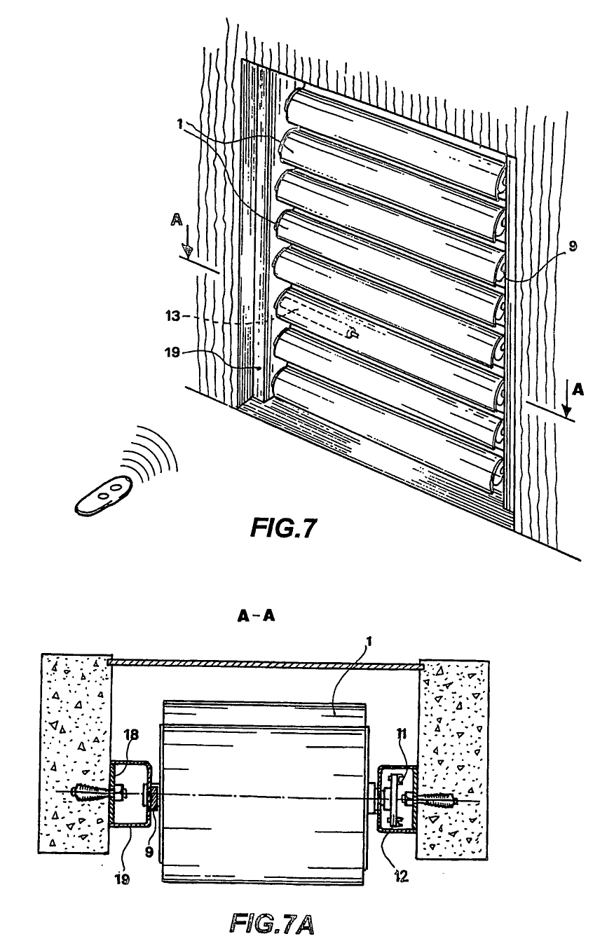

FIG. 7 shows a specific embodiment of the present invention; and

FIG. 7A is a sectional view of the system of FIG. 7, taken along line A-A.

With reference to said figures, a system according to the present invention comprises a plurality of sunshade slats 1, generally formed with extrusions of a light-weight metal alloy like aluminium, equidistant thereamong, at a distance such as to be couplable thereamong in order to totally shield from light and rain when arranged at zero-tilt, as it is also apparent from FIG. 2.

The system, as it will be detailed, allows an integral motion of the slats 1, which always keep parallel thereamong.

A tubular motor 13 is located inside the hollow of one of the slats 1, wherein a seat therefor is obtained, e.g. by interposing a sort of transverse stringers or ribs 14, optionally reinforced with sheet metal bends.

Among these stringers there is suitably fixed a member, e.g. made of plastic, which in turn is splined to the shaft of the tubular motor 13, thereby making said motor integral to the slat 1 in which it is inserted.

When the motor is activated, via a button strip or a remote control, e.g. an infrared remote control, it develops a torque and drags into rotation said slat 1 to which it has been made integral. Then, the torque is transmitted to a rotary driving device, generally indicated by 10, comprising two rods 11 made of extruded metal, e.g. of aluminium, and of a substantially rhomboid-shaped member 12, preferably made of nylon.

To this rhomboid-shaped member 12 there remain hinged the two rods 11, at the ends along the main axis of the rhomboid.

The two rods 11 run along the entire set of slats 1, and the former, connected to the respective rhomboid-shaped members 12 and thereby to the respective rotary devices 10, transmit the motion from the level of the motive slat, in which the motor 13 is inserted, to all the other slats.

Hence, by revolving the shaft of the motor, all the slats arrange according to the incidence attained by the slat incorporating the motor itself.

The contours of the slats 1 are closed with caps 2, preferably made of nylon.

The caps 2, whose shape reproduces that of the end section of the profiles of the slats so as to exactly close the recesses thereof, are provided with suitable flaps 15. These flaps allow a good restraining inside the hollow of the metal extrusions 1 and enable the torque imparted by the motor 13 to be uniformly transmitted to the thin sections.

In each of the caps 2 a hole is obtained, located centrally and symmetrically with respect to the plan surface. Each of these holes contains a metal projecting cylinder-shaped member 3, operating as reinforcement of the structure generally made of plastic.

Therefore, according to the present invention each slat 1 has two caps 2a and 2b, to close its end at the driving device side and the end at the opposite side, respectively.

Accordingly, the caps 2a and 2b are shaped differently therebetween.

Each of the caps 2a located at the side of the driving structure 10 has a cylinder-shaped projection 16 allowing a coupling of the cap itself to the remainder of the device.

In fact, inside of these projections there is obtained a spline toothing, which couples to a spline obtained on a drilled coupler 8.

Such a coupler 8 couples said caps to the device 10 in charge of transmitting the rotation to the array of slats, and it is characterized in that it is made of two cylinder-shaped trunks having different-diameter sections, apt to implement two respective couplings thereon.

By virtue of the splines obtained on said different-diameter trunks, on the one hand there is implemented a male-female joint with the caps 2a of the slats 1, and on the other hand there is generated an analogous joint with the rhomboid-shaped member 12 of the rotary driving device, it also provided with corresponding toothings on a suitably obtained recess.

Essentially, the coupler 8, drilled so as to house the projections of the reinforcement pipes 3, engages and enters on the one hand into the cylinder-shaped projection 16 of the caps 2a, and on the other hand in the recess of the rhomboid 12.

Moreover, onto the coupler 8 there are sequentially packed a bush 21, made e.g. of nylon, acting as a raiser apt to facilitate the inserting of the former inside the seat onto the rhomboid 12, and a washer 7, preferably made of stainless steel, interposed in order to decrease friction during the revolving.

Hence, by virtue of the implemented coupling the motor-developed torque is transmitted to the rotary device 10 via the coupler 8.

The entire driving structure 10, i.e. the rods 11 and the rhomboid-shaped members 12, is enclosed in a first upright 4.

A second upright 5, analogous to the first upright, is located onto the opposite side of the slats 1.

The upright 4, as well as the upright 5, is substantially structured in two sections that, connected therebetween, form a closed box member.

The two sections are an anchoring section 18 and a load-bearing C-section 19, both made, e.g., of extruded aluminium.

As it is apparent from FIG. 1, the motor 13, constrained and made integral to the slat in which it is inserted as mentioned above, is located at the side where there is no driving device, with one end thereof housed inside a hollow 22 obtained onto the cap 2b of FIG. 3B.

More generally, also the caps located at the side where there is no rotary device 10 have cylinder-shaped projections 17.

On said projections there is applied a removable locking clip 9 that is in sliding contact with a bush 20, generally made of nylon.

The locking clip 9 has the main function of keeping the slats 1 inside their seats.

In fact, as a further innovative feature, it has been provided that said slats be easily removable when required, e.g. when inspections or component replacements are needed during the maintenance, with a mere step of extracting.

When the clip 9 is extracted (FIG. 6A), the slat 1 interposed between the two uprights 4 and 5 is allowed (FIG. 6B) to slide and translate from the side where there is no rotary device 10, so that the portion 17 of the cap 2b may enter the recess of the upright 5.

Thus, it is easy to extract the cap 2a from the coupler 8 and to remove the slat 1 from its seat (FIG. 6C).

In order to facilitate this procedure, the cylinder-shaped trunk of said coupler, destined to enter the projection 16 of the cap 2a, is shaped so as to allow an easier transit of the projection of the cylinder-shaped reinforcement member 3, via a suitably dimensioned notch.

Vice versa, when it is desirable to again prearrange a slat in an operative position, the problem posed by the translatory degree of freedom is solved just by means of the locking clip 9, which is to be inserted onto the portion 17 of the cap 2b from the system side where there is no rotary device 10.

Moreover, the use of a clip 9 for the mounting of the slat or slats provides higher flexibility during the mounting, as thus there is allowed an improved adjustment of the slacks that might be generated in case the two uprights are not perfectly aligned. In fact, the installer will avail him/herself of a set of clips having different thicknesses and sizes so as to optimize the adjusting of the slacks with the selection of the clips best suited to the different configurations of each mounting.

The present invention was hereto described according to a preferred embodiment thereof, given by way of a non-limiting example. It is understood that there may be other embodiments, all to be construed as falling within the protective scope thereof, as defined by the appended claims.

1. An automatized solar shielding system, comprising a plurality of slats, revolvable via a driving device driven by a motor, and a pair of uprights apt to operate as support of said slats, characterized in that:
one upright of said pair of uprights is hollow and apt to contain said driving device; and
said motor is contained inside of one of said sunshade slats.

2. The system according to claim 1, wherein each of said uprights comprises an anchoring section and a load-bearing C-section, connected therebetween so as to form a closed box member.

3. The system according to claim 2, wherein said sections are made of extruded aluminum.

4. The system according to claim 1, wherein said driving device comprises a plurality of substantially rhomboid-shaped members, each of said rhomboid-shaped members being integrally connected to a respective slat at one end of the latter.

5. The system according to claim 1, wherein said driving device comprises at least one rod for connecting said rhomboid-shaped members.

6. The system according to claim 5, comprising two rods for connecting said rhomboid-shaped members.

7. The system according to claim 6, wherein said two rods are respectively hinged at opposite vertexes of each of said rhomboid-shaped members.

8. The system according to claim 1, wherein said motor is a tubular motor having a main body integral to the slat containing it.

9. The system according to claim 1, wherein each of said slats is hollow and apt to be closed, at each of is ends, by a corresponding cap whose shape reproduces that of the end section of the slat itself.

10. The system according to claim 9, wherein each of said caps comprises a cylinder-shaped projection for the coupling to said rhomboid-shaped member.

11. The system according to claim 9, wherein each of said caps comprises a cylinder-shaped projection for the coupling to the upright.

12. The system according to claim 9, wherein said caps are made of nylon.

13. The system according to claim 11, wherein on each of said cylinder-shaped projections there is inserted a locking clip for adjusting the mounting slacks.

14. The system according to claim 13, wherein said locking clip is made of nylon.

15. The system according to claim 6, wherein said rods are made of extruded metal.
